(19) United States
(12) Patent Application Publication
(10) Pub. No.: US 2023/0201768 A1
(43) Pub. Date: Jun. 29, 2023

(54) AIR PURIFYING SYSTEM

(71) Applicant: NuWave, LLC, Vernon Hills, IL (US)

(72) Inventors: Jung S. Moon, Long Grove, IL (US); Byung Gab Choi, Lake Villa, IL (US); James Moon, Vernon Hills, IL (US); Zeng Qing Ping, Shanwei City (CN); Kim Jong Rok, Seoul (KR); Luo Fei, Foshan City (CN)

(21) Appl. No.: 17/646,086

(22) Filed: Dec. 27, 2021

(51) Int. Cl. B01D 53/88

(52) U.S. Cl. CPC B01D 53/885; B01D 2255/806

(57) ABSTRACT

An air purifying system having two series of specific filters vertically arranged around a central, cylindrical electrostatic filter to facilitate removal of particles from the air. Removable filters include a pre-filter, an activated carbon filter and a cold catalyst filter, in addition to the electrostatic cylindrical filter. Additional filters or alternate filters may be used, so long as there is no negative impact on the system efficiency and effectiveness.

### TECHNICAL FIELD OF THE INVENTION

The present application relates to air purifying systems. Particularly, the application relates to an improved programmable, electrostatic air purifier which removes smoke, dust, pollen, bacterial and other particulate matter from air.

### BACKGROUND OF THE INVENTION

As is well known to those skilled in the art, an air purifier is used to take in ambient air and provide purified clean air by removing contaminants. There are many ways for removing contaminants with varying results.

For example, a HEPA filter is a type of pleated mechanical air filter. It is an acronym for “high efficiency particulate air [filter]” (as officially defined by the U.S. Dept. of Energy). This type of air filter can theoretically remove at least 99.97% of dust, pollen, mold, bacteria, and any airborne particles with a size of 0.3 microns (µm). The diameter specification of 0.3 microns responds to the worst case; the most penetrating particle size (MPPS). Particles that are larger or smaller are trapped with even higher efficiency. Using the worst-case particle size results in the worst-case efficiency rating (i.e., 99.97% or better for all particle sizes). However, HEPA filters require repeated replacement to maintain this efficiency.

Another type of filter is an electrostatic filter. These filters use an ionizer to create an electrically charged field. Particles passing through this field become electrically charged by the corona discharge of the ionizer and are collected by electrostatic attraction to an electrostatic filter having a polarity opposite to the polarity of the newly charged particles.

In many air filtering systems, combination of filter types are used to improve efficiency. As shown in FIG. 1, a conventional air purifier includes a pre-filter 102, an ionizer 104, an electrostatic filter 106 and a final filter 108. The pre-filter 102 acts primarily to filter relatively large particles, while the ionizer 104 functions to charge smaller particles electrically to have a positive polarity. This is done by corona discharge between a discharge electrode 104b and ground electrodes 104a positioned on both sides of the discharge electrode 104b. The electrostatic filter 106 has a plurality of horizontal partitions 106a bearing a negative polarity. When the positively charged particles flow between the horizontal partitions 106a of the electrostatic filter 106, the particles are adsorbed and collected on the negatively charged horizontal partitions by electrostatic attraction. The final filter 108 functions to filter fine dust or bacteria not filtered by the electrostatic filter 106.

The effectiveness of these filtering systems is rated based on Clean Air Delivery Rate (CADR), a standard set by the Association of Home Appliance Manufactures (AHAM). The CADR is a measure of the volume of clean air (in cubic feet) produced per minute by a filtering system—i.e., a CADR of 200 means 200 cubic feet of clean air is produced every minute. The rating factors in a system’s air flow (cfm) and filter efficiency. That is, a system with a 200 cfm flow and 90% efficient will have a CADR of 180. A general rule of thumb is that the CADR should be about two-thirds of the square footage of an area being filtered. For example, an air filtering system used in a 20′ × 20′ room (400 sqft. area) should have a CADR of about 267.

The CADR is measured for specific room contaminants, including smoke, dust and pollen. A different CADR rating is applied to each of these contaminants as illustrated in TABLE 1 below.

TABLE 1

CLEAN AIR DELIVERY RATE (CADR) SCALE

| | |
|---|---|
| Smoke | 0-400 |
| Dust | 0-450 |
| Pollen | 0-450 |

However, the efficiency will decrease as the filter and collecting unit become too dirty. In most cases, the filters are easily replaceable, but the collecting unit may be more difficult to clean in prior art systems.

These and other problems are addressed by the present device and methods to provide a system with numerous advantages in operation and effectiveness.

### SUMMARY OF THE INVENTION

There is disclosed herein an improved air purifying system which avoids the disadvantages of prior devices while affording additional structural and operating advantages.

Generally speaking, the air purifying system comprises an outer housing having a control panel, an air inlet and an air outlet, a filter chamber positioned within the outer housing and comprising a series of filters, and a fan positioned within the outer housing, electrically coupled to the control panel and configured to draw air into the air inlet, through the filter chamber and then push the air out through the air outlet.

Specifically, the disclosed air purifying system comprises an outer housing having a control panel, an air passage having an air inlet positioned on the outer housing and an air outlet positioned on the outer housing, a filter chamber positioned within the air passage between the air inlet and the air oulet and comprising a series of filters, wherein the series of filters comprises a first series of planar filters, a second series of planar filters, and a cylindrical filter positioned between the first series of planar filters and the second series of planar filters, and a fan positioned within the outer housing, electrically coupled to the control panel and configured to draw air into the air inlet, through the filter chamber and then push the air out through the air outlet.

The air purifying system comprises at least two filters selected from a group of filters consisting of a pre-filter, an activated carbon filter, a cold catalyst filter, and an electrostatic filter. Preferably, the air inlet comprises air openings on sides of the housing and an air outlet on a top surface of the outer housing.

Alternatively, the air purifying system further comprises a horizontal filter within the filter chamber, positioned above the cylindrical filter before the air outlet.

In specific embodiments, the air purifying system is pre-programmed with operational modes which facilitate efficiency by alerting for poor air quality, filter cleaning or removal alerts, and automatic on and off modes.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments and other aspects thereof, from an inspection of which, when considered in connection with the following description, the subject matter sought to be protected, its construction and operation, and many of its advantages should be readily understood and appreciated.

FIG. 1 is a schematic showing the general structure and operation of prior art electrostatic air purifying system;

FIG. 2 is a left side view of an embodiment of the disclosed air purifying system;

FIG. 3 is a right side view of the embodiment of FIG. 2;

FIG. 4 is a front side view of the embodiment of FIG. 2;

FIG. 5 is a rear view of the embodiment of FIG. 2;

FIGS. 6A and 6B are top views of an embodiment showing a preferred control panel and air vent opening;

FIG. 7 is a rear view of the embodiment of FIG. 2 showing a rear panel removed to expose two series of filters and a cylindrical filter in a filter chamber;

FIG. 8 is close up of the filter chamber of FIG. 7 with the cylindrical filter removed;

FIG. 9 is a perspective view of a series of four filters capable of use in either filter series of the embodiment of FIG. 2;

FIG. 10 shows multiple views of an embodiment of the pre-filter;

FIG. 11 shows multiple views of an embodiment of the carbon filter;

FIG. 12 shows multiple views of an embodiment of the ozone (cold-catalyst) filter;

FIG. 13 is a perspective view of an embodiment of the cylindrical electrostatic filter;

FIG. 14 is a top view of the electrostatic filter of FIG. 13;

FIG. 15 is a bottom view of the electrostatic filter of FIG. 13;

FIG. 16 is an illustration of the air filtering pathway through the two filter series, through the cylindrical filter and then upward to the outlet vent; and

FIG. 17 is an illustration of the air filtering pathway through two filter series, through a cylindrical filter, upward through a final horizontal filter and then out the outlet vent.

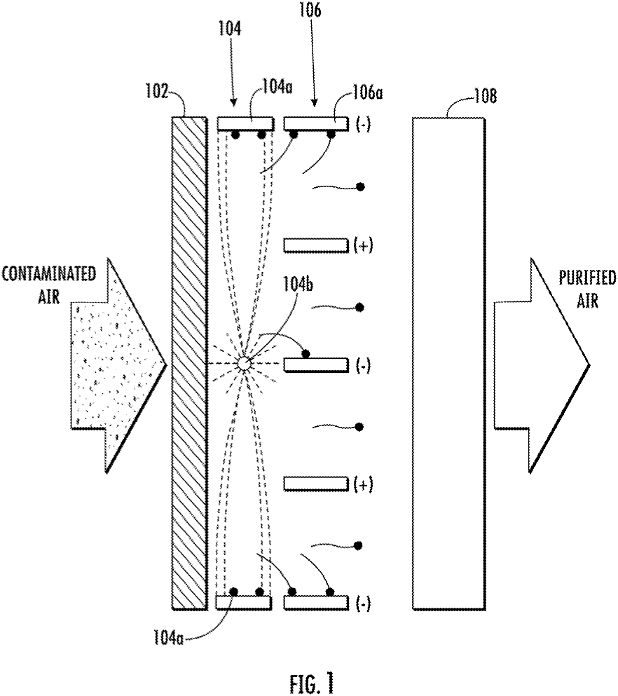

### DETAILED DESCRIPTION OF PREFERRED EMBODIMENTS

While this invention is susceptible of embodiments in many different forms, there is shown in the drawings, appended documents and tables, at least one embodiment will herein be described in detail with an understanding that the present disclosure is to be considered as an exemplification of the principles of the invention and is not intended to limit the broad aspect of the invention to any specific embodiments illustrated or described.

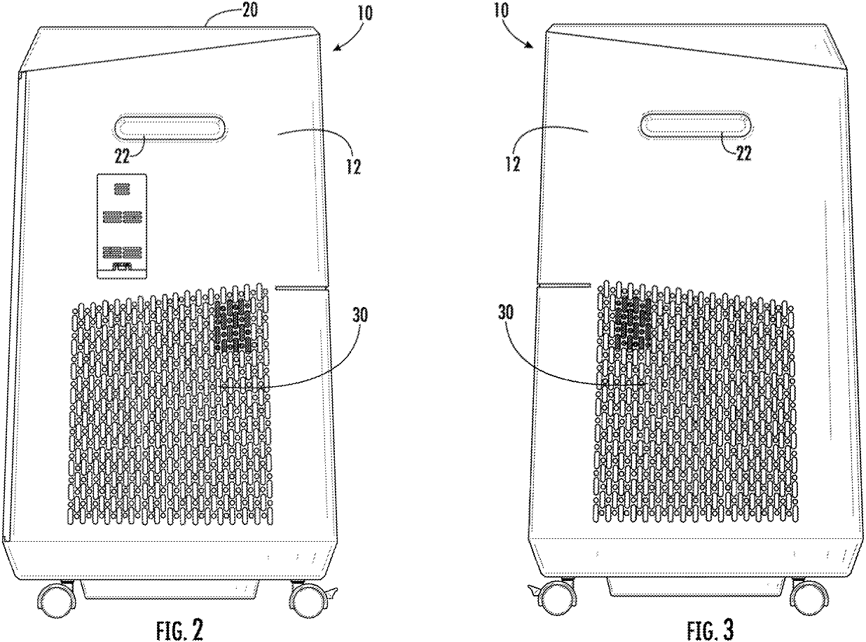

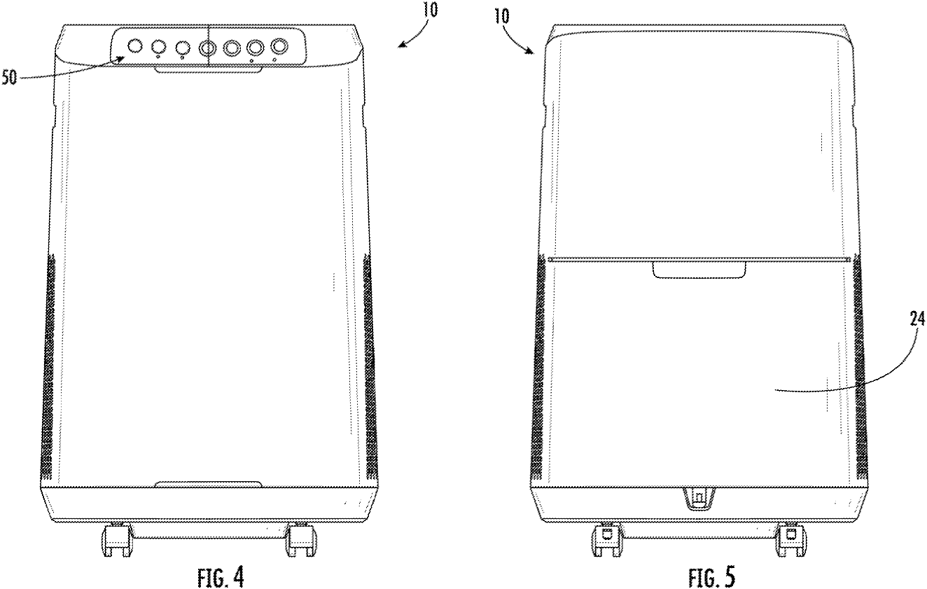

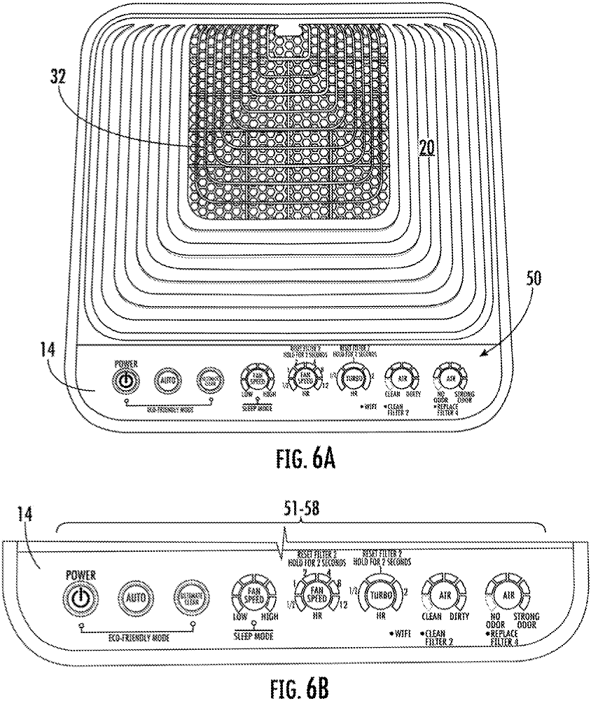

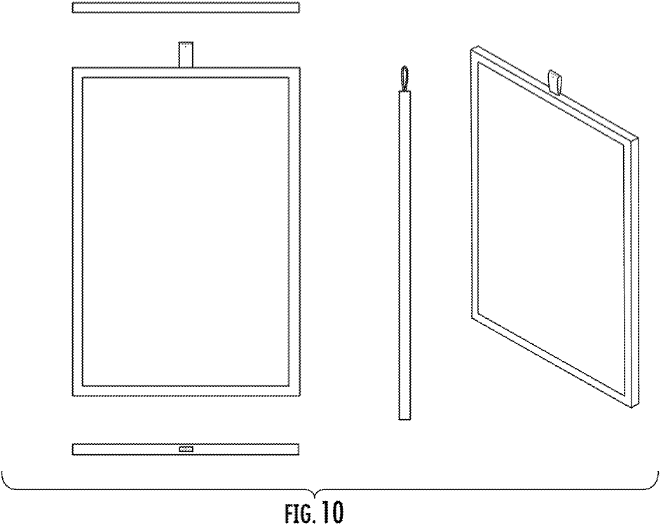

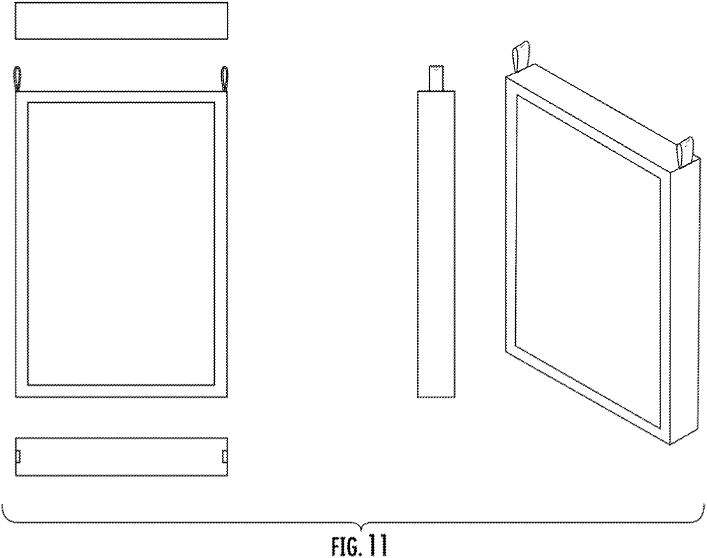

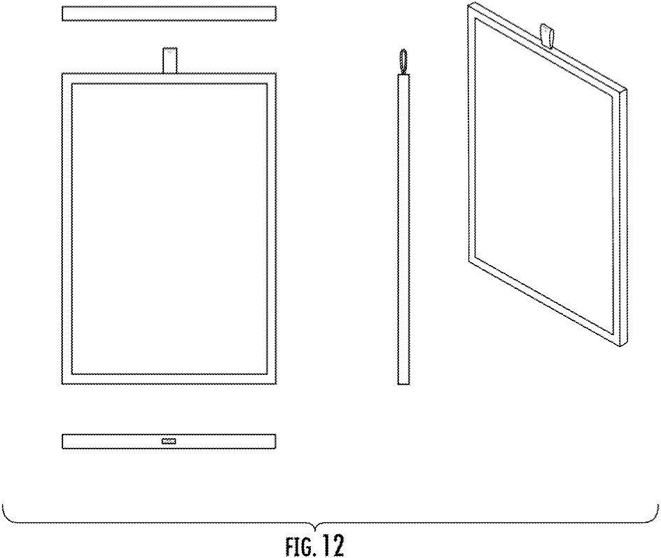

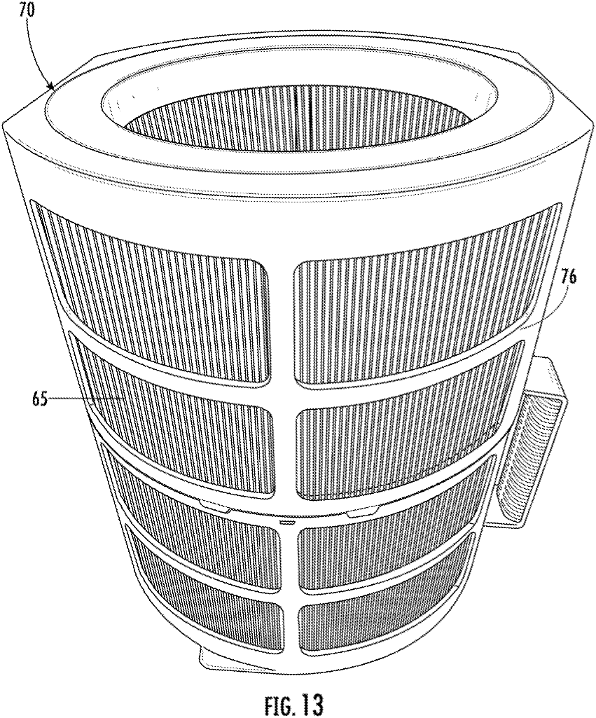

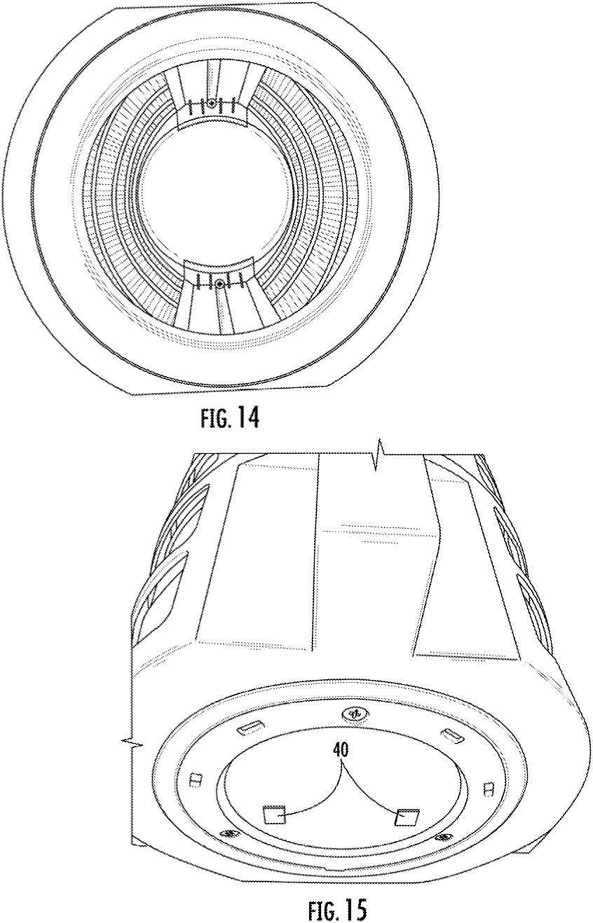

Referring to FIGS. 2-17, there is illustrated at least one preferred embodiment of an air purifier system, generally designated by the numeral 10, and its several components. The particular illustrated air purifier system or purifier 10 is portable and for a home or small office space. However, modification can be made to the disclosed embodiments to provide a smaller, larger or fixed system, if desired.

With reference to FIGS. 2-5, the purifier 10 is comprised of an outer housing 12, including a preferred control panel 14 on a front edge of the top surface 20. Handles 22 are provided on the sides for lifting or moving the purifier 10, and a removable rear panel 24 conceals a filter chamber 26. On each side of the purifier 10 adjacent the rear panel 24 are air intake vents 30 (see FIGS. 2 and 3). Having two large intake vents 30 helps maximize efficiency of the air purification process. The top surface 20 of the purifier 10 includes an air discharge vent 32 comprised of a substantially open area, covered by a plurality of air slats for the directional discharge of air after it has been filtered. Preferably, the discharge vent 32 is strategically placed on the top surface 20 to minimize the likelihood of having objects, liquids or other materials fall into the vent 32.

As shown in FIGS. 6A and 6B, the control panel 14 has numerous buttons 50 for setting options. In addition to the “Power” button 51, the control panel 14 includes “Auto” 52, “Fan Speed” 53, “Timer” 54, “Turbo” 55, “Air” 56, and “Odor” 57. An “Ultimate Clean” button 58 may also be added to the control panel 14. The operation of these buttons and the system 10, in general, is detailed further below. The panel 14 is preferably touch-control with backlighting and light indicators to show operation modes and operation levels.

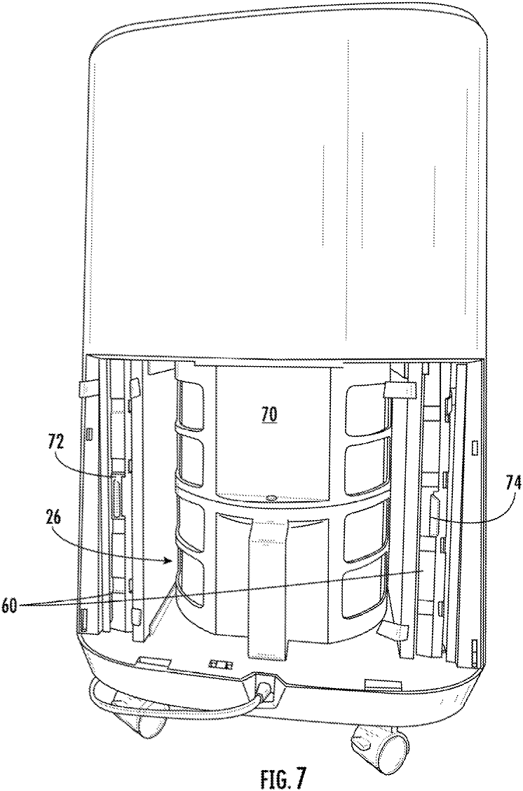

Referring to FIGS. 7-12, the filter chamber 26 and individual planar filters 60 are shown. The filter chamber 26 has slots 38 for three planar filters adjacent each of the air intake vents 30—i.e., two series of three filters. Planar filters are defined herein as flat, typically rectangular, filters. These planar filters can vary considerably in thickness but are best described as having two opposing faces wherein two parallel planes consistently intersect a base surface of each face. The actual opposing faces of the filter may have corrugation, dips, recesses, protrusions, and the like.

More notably, a central cylindrical filter 70 is positioned between the first and second filter series, 72 and 74 respectively, within the housing 12. There are preferably three filter slots 38 on each side of the cylindrical filter 70, but more than three and as few as two filters can be used in each series. Each of the three filters 60 should have a customized slot 38 to prevent mixing up the order of the filters 60. The filters 60 can be easily slid into and out of their respective slots 38 for cleaning and/or replacement.

In a preferred embodiment, the first filter on each side is a pre-filter 62. The pre-filter 62 is used to remove larger particles from the incoming air. These large particles may pose a threat to the other filters in the chamber 26.

A second preferred filter for use in the system 10 is known as a cold catalyst filter. The cold catalyst filter 66 is used to remove pollutants and harmful volatile organic compounds (VOCs) from the air. The cold catalyst filter 66 decomposes a variety of harmful gases, such as formaldehyde, ammonia, benzene, hydrogen sulfide and more VOCs, to produce water and carbon dioxide.

Finally, another preferred filter is an activated carbon filter 68 for removal of odors from the filtered air.

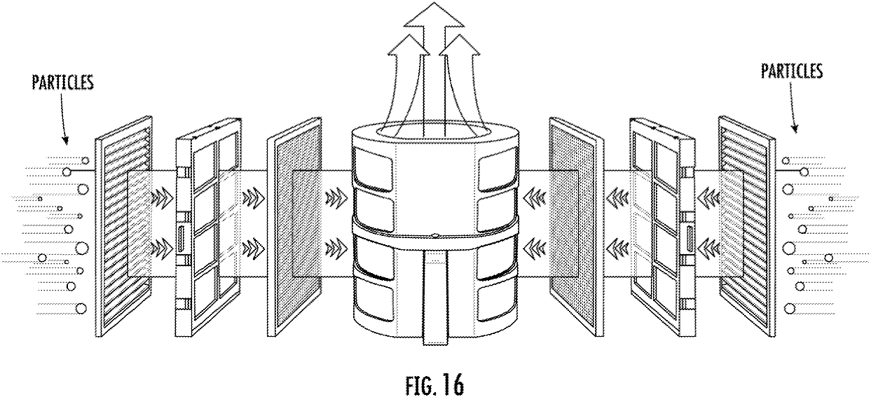

A fan 44 is positioned above the filter chamber 26 within the housing 12 to draw air into the air intake vents 30 on the sides of the purifier 10, through each of the filters 60 in the first and second series in the filter chamber 26, though the cylindrical filter 70, and then out the vents 32 at the top of the system 10 (see FIG. 16). The speed of the fan 44 is electronically controlled at the control panel 14. Various air sensors and or timers may be used to indicate a time when each of the filters 60 needs to be cleaned or replaced.

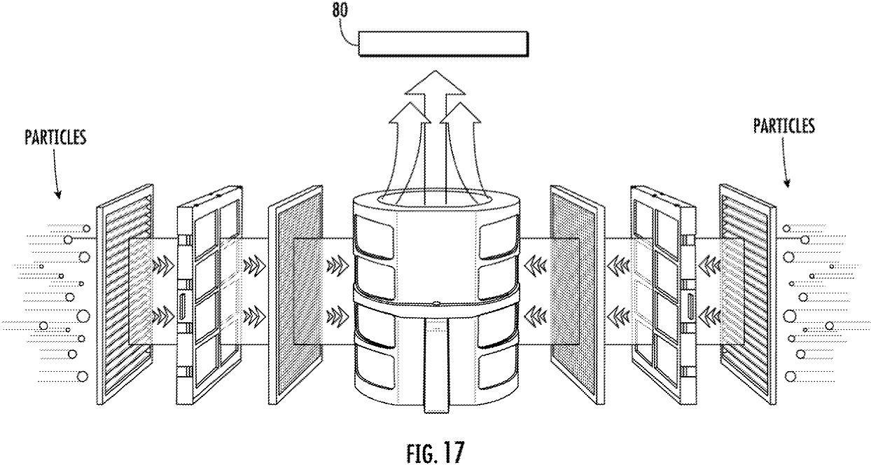

In an alternate embodiment, shown in FIG. 17, a final horizontal filter 80 may be used in a position just above the cylindrical filter 70.

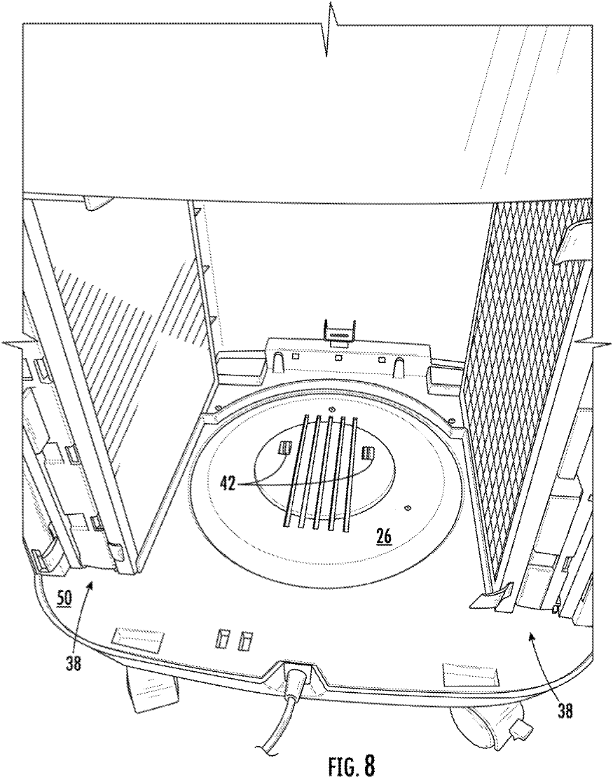

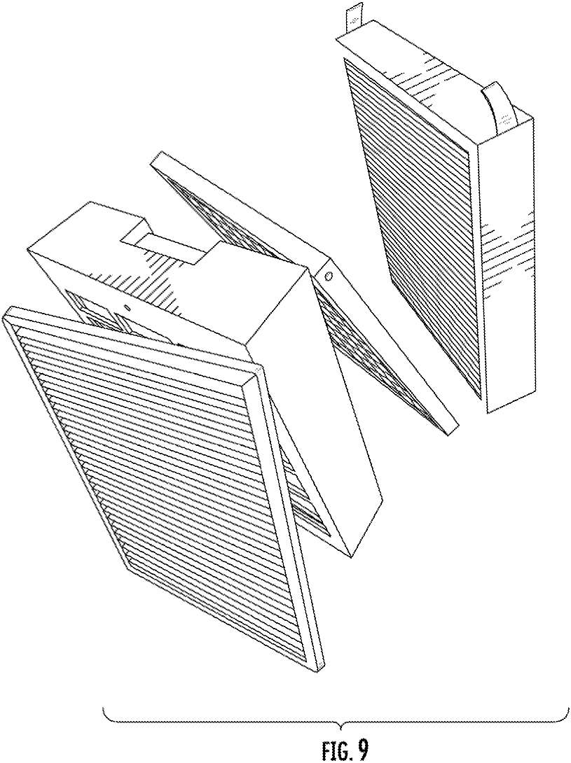

FIGS. 13-15 show a preferred embodiment of the cylindrical electrostatic filter 64 used in the disclosed air purifier system 10. The filter 64 can be readily rinsed clean to remove particles before returning it to the center area 38 in the filter chamber 26. The electrostatic filter 64 has two contacts 40 on a bottom side (FIG. 15) which couple to contacts 42 shown within the filter chamber 26 (see FIG. 8). These two sets of contacts, 40 and 42, electrically couple the electrostatic filter 64 to the control panel 14. The electrostatic filter 64 is able to charge incoming contaminant particles which are then collected on an oppositely charged surface provided by the plurality of filter strips 65. These strips 65 are arranged close together within the filter frame 67 to maximize efficiency.

As shown, the filter 64 comprises a cylindrical housing 76 and the plurality of spaced filter strips 65 within. The strips 65 can be charged with about 8,000 volts of electricity during use to charge and capture particles as they pass between the strips 65. The number of strips 65 used is preferably about 10-15 strips per inch (4-6 per cm), most preferably about 12 strips per inch (about 5 per cm).

### Operation of Air Filter System

Returning to FIG. 6B, the system 10 can be operated from the control panel 14. Each of the buttons 50 is backlit to illuminate when the button is pushed and will remain lit while the related function is operating. When pushing any button 50, the system 10 will emit a single beep. When the selected function is complete, a single long beep (200 ms) will be emitted.

The system 10 can be turned on by depressing “Power” button 51. A beep will sound when the system 10 activates. However, when the system 10 is initially plugged into a power source, the unit goes into standby mode. When off, the “Power” button 51 is lit with a red color, which turns to green when the system 10 is turned on. During operation, the DUST & ODOR LED is lit. The following is a list of preprogrammed functions and modes for the system 10.

Reset WIFI connection: press the “Power” button 51 for three seconds;

Place system 10 in “Sleep Mode”: press the “Fan Speed” button 53 for two seconds;

Reset the Dust (clean filter) time sequence: press “Timer” button 54 for two seconds. For example, when a filter 60 is removed and cleaned, performing this step will reset the time frame for the Dust Filter—approximately six months.

Reset the Formaldehyde (replace filter) time sequence: press “Turbo” button 55 for two seconds. For example, when you replace a filter 60 for odor, performing this step will reset the time frame for the catalyst filter 66—approximately five years.

If a user has chosen any mode to run the unit 10, after power off and then power on, the unit will continue to run the same mode.

Preferably, the default upon power up will go into a low fan speed mode. While ON, operation of the system 10 can be changed as follows: Pressing “Timer” button 54 once will be for 30 minutes of operation; twice for 1 hr; three times for 2 hours, etc. Likewise, pressing the “Fan Speed” button 53 will increase fan speed by one increment (e.g., levels 1-10 or low/medium/high). Pressing “Ultimate Clean” button 58 will clean at the highest fan speed until turned off. Pressing “Auto” button 52 will clean air at varying fan speeds, due to different dust and odors, until turned off. Pressing “Turbo” button 55 once will operate for 30 minutes; twice for 1 hr; three times for 2 hours, etc. If no other button 50 is pressed after the “Turbo” button 55, then the system 10 will turn OFF after the selected time.

Pressing the “Auto” button 52 runs the system 10 automatically according to current air quality. AUTO mode backlight is off when the unit is not in AUTO mode. Pressing the “Auto” button 52 will turn the backlight on. The system 10 will operate automatically and continuously according to current air quality conditions. Fan speed is automatically adjusted according to the changing air quality. For example, if the air quality is poor, the fan speed will increase. But, as the air quality improves (i.e., becomes fair to good), the fan speed will slow. Fan speed will vary automatically according to air quality.

The “AUTO” function and “FAN SPEED” button cannot work together. That is, while in AUTO mode, if the “FAN SPEED” button 53 is pressed, the AUTO function will turn off (manual fan speed mode). While the unit is running in AUTO mode, the user can adjust operation time by pressing the “TIMER” button 54. Conversely, while on manual fan speed, pressing the “Auto” button 52 will change to AUTO mode.

The “AUTO” mode and “ULTIMATE CLEAN” button 58 can work together. Even if the unit is turned OFF and a user presses the “Auto” button 52, then the system 10 will automatically turn on and go into AUTO mode. It will clean (Fan speed will change due to changing air conditions from dust, particles and odors in an area) until turned off.

The “Ultimate Clean” mode runs the system 10 at the highest fan speed while air quality is poor (e.g., parts per million at 2.5 µm is over 10: PM2.5>10). Even if the unit is turned OFF (Power OFF), and the user presses “Ultimate Clean” button 58, the system 10 will clean at a determined fan speed until turned off.

Ultimate clean mode can work together with AUTO mode. When both AUTO mode and ULTIMATE CLEAN mode are selected, the system 10 will run in ULTIMATE CLEAN mode initially. However, after the air quality condition improve (e.g., PM2.5<10), the system 10 goes into AUTO mode.

Further, ULTIMATE CLEAN mode can work together with TURBO mode. When both “Turbo” button 55 and “Ultimate Clean” button 58 are pushed, the system 10 will run TURBO mode for about 30 minutes, then go into ULTIMATE CLEAN mode.

The “Turbo” button 55 causes the system to run with highest fan speed for a specific time: e.g., half hour, 1 hour, or 2 hours. Even if the unit is OFF, pressing the Turbo button 55 once, the system 10 will operate for 30 minutes; twice extends operation to 1 hour; and three times will operate the system 10 for 2 hours. If no other button is pressed after the “Turbo” button 55, then the system 10 will turn OFF after the selected time. The default fan speed for TURBO mode is about 1030 RPM.

TURBO mode can work with AUTO. By pressing the “Turbo” button 55 twice and then the “Auto” button 52 , the system 10 will go into TURBO mode for one hour then AUTO mode until turned off.

The “Fan Speed” button 53 adjusts fan speed. Preferably there are six fan speed levels. Even if the system 10 is OFF (Power OFF), pressing the “Fan Speed” button 53 will turn the system 10 on with a low fan speed. Pressing the “Fan Speed” button 53 once will display one bar on the panel 14, twice will light two bars, etc., until the 7th time, it will return to the lowest speed level. The preferred fan speed levels are 400 RPM, 526 RPM, 652 RPM, 778 RPM, 904 RPM, and 1030 RPM.

The “Timer” button 54 adjusts the time of operation. The six preferred time increments are 30 mins, 60 mins, 120 mins, 240 mins, 480 mins, and 720 mins. Even if the system 10 is OFF, pressing the “Timer” button 54 will go into default for 30 minutes at a low fan speed (lowest level). Pressing the “Timer” button 54 will cause the backlight to illuminate. Similar to the fan, pressing the “Timer” button 54 once will light a first bar on the control panel 14, a second press will light a second bar, etc. until the 7th press which will turn off the TIMER and all associated backlight will be turned off as well.

The control panel 14 includes several indication features on the display. An “Air Quality” indicator is included on the display. The indication light for this feature will turn on as soon as the unit is turned on. Based on the various sensor readings, one of six air quality levels will be indicated: clean (green) to poor (red). The system 10 will display the air quality of the incoming air according to current air quality measurements.

Also, there is a “CLEAN FILTER” indication LED. This LED indicator will turn off when the filter is clean (e.g., under 3 months of use). The LED indicator will turn blue after a period of time (e.g., after 3 months of use), letting a user know to clean the filters. If the filters are not cleaned and the indicator reset, the LED indicator will turn red (e.g., after 6 months of use). Preferably, the time of use (e.g., 3 or 6 months) is accumulated by working hours. To clear previous use time (i.e., reset sensor), press “Timer” button 54 for 2 seconds until beep sounds when the system is turned off.

An ODOR indication light turns on as soon as the unit is operated. There are preferably six levels of air quality indication from NO ODOR (green) to STRONG ODOR (red). The control panel 14 will display “odor indication bars” according to the current odor measurement.

There is also a light indicator next to “clean” that is below the “Odor indicator”. When a filter needs to be replaced, the light will turn red (approximately 5 years).

To reset the filter timer, press the “Turbo” button 55 for two seconds while the system 10 is ON. When a beep sounds the timer is reset for another, e.g., 5 years.

When air quality regarding odor is poor (highest level, red bar), an alarm beep will be triggered. At the same time, the LED indicator bars for odor will start blinking. A user may turn off the alarm (blinking and beep sound) by pressing “Auto” button 52 and “Fan Speed” button 53 together.

A WIFI indication light can also be found on the display of the control panel 14. To activate, the “Power” button 51 is pressed and held for up to three seconds until a beep sounds and a dot next to the WIFI indication is flashing at the same time. As soon as the WIFI is connected, the LED indicator light will light up solid. To turn off WIFI, pressing and holding the “Power” button 51 while the system 10 is ON, for up to 3 seconds until the beep sounds, the WIFI will be disconnected and the LED indicator light will be turned off. If there is no WIFI available, after 10 seconds, the LED indicator light turns off.

An LED brightness adjustment is defaulted to 100% power. After about 30 seconds without any button pushing, the LED light will be turned down to about 30% power automatically. Once a button is touched, the LED will go back to 100% power. When the system 10 is working, the LED lights can be completely turned off (0% power) by pressing and holding the “FAN SPEED” button 53 for at least two seconds.

Pressing the “Power” button 51 and the “Ultimate Clean” button 58 together at anytime will place the system 10 into an automatic on/off mode. That is, when the air quality is poor, the system 10 will turn on automatically and run in AUTO mode. The LEDs corresponding to Power and AUTO mode will be lit during this time. When the air quality is good, the unit will turn off automatically. The LED for Power will be illuminated (e.g., green) while the LED for AUTO mode will be off. To stop the automatic on/off mode, the “Power” button 51 and the “Ultimate Clean” button 58 must be pressed together again. The LED for Power will be turned to red.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants’ contribution. The actual scope of the protection sought is intended to be defined in the following claims when viewed in their proper perspective based on the prior art.

What is claimed is:

1. An air purifying system comprising:
an outer housing having a control panel;
an air passage having an air inlet positioned on the outer housing and an air outlet positioned on the outer housing;
a filter chamber positioned within the air passage between the air inlet and the air outlet and comprising a series of filters;
wherein the series of filters comprises:
a first series of planar filters,
a second series of planar filters, and
a cylindrical filter positioned between the first series of planar filters and the second series of planar filters; and
a fan positioned within the outer housing, electrically coupled to the control panel and configured to draw air into the air inlet, through the filter chamber and then push the air out through the air outlet.

2. The air purifying system of claim 1, wherein the first series of planar filters comprises at least two filters selected from a group of filters consisting of a pre-filter, an activated carbon filter, a cold catalyst filter, and an electrostatic filter.

3. The air purifying system of claim 2, wherein the second series of planar filters comprises at least two filters selected from a group of filters consisting of a pre-filter, an activated carbon filter, a cold catalyst filter, and an electrostatic filter.

4. The air purifying system of claim 3, wherein the selected filters are arranged vertically.

5. The air purifying system of claim 3, further comprising a clean air delivery rate of at least 200 ft³/min.

6. The air purifying system of claim 5, wherein the clean air delivery rate is at least 250 ft³/min.

7. The air purifying system of claim 1, wherein the air inlet comprises air openings for about 360° about a base of the housing.

8. The air purifying system of claim 3, wherein the air outlet is on a top surface of the outer housing.

9. The air purifying system of claim 1, further comprising a horizontal filter within the filter chamber.

10. The air purifying system of claim 9, wherein the horizontal filter is positioned above the cylindrical filter before the air outlet.
